(19) United States
(12) Patent Application Publication
(10) Pub. No.: US 2007/0172715 A1
(43) Pub. Date: Jul. 26, 2007

(54) Compact, modular regenerative fuel cell

(75) Inventors: Trent Molter, Glastonbury, CT (US); Ken Reifsnider, Storrs Mansfield, CT (US); Frano Barbir, Split (HR)

Correspondence Address: McCarter & English, LLP, Financial Centre, Suite 304A, 695 East Main Street, Stamford, CT, 06901-2138, US

(73) Assignee: University of Connecticut

(21) Appl. No.: 11/643,073

(22) Filed: Dec. 21, 2006

Related U.S. Application Data
(60) Provisional application No. 60/758,172, filed on Jan. 11, 2006.

(51) Int. Cl. H01M 8/04; H01M 8/18

(52) U.S. Cl. 429/34; 429/38; 429/21

(57) ABSTRACT

The invention provides a fuel cell system. The fuel cell system can include a modular power section, the power section including at least one power module, and at least one modular energy storage section, the energy storage section including at least one reactant storage module. The power section can include a plurality of power modules. Similarly, the energy storage section can include a plurality of reactant storage modules. At least one of the power module and reactant storage module can include fluids quick disconnect fittings to operably couple the module to the fuel cell system to facilitate modular operation. In accordance with a further aspect, the system can further include a regeneration section, the regeneration section having an electrolyzer configured and adapted to dissociate water received from the power module into hydrogen and oxygen by way of a fluids manifold.

### CROSS-REFERENCE TO RELATED APPLICATIONS

This application claims the benefit of priority from U.S. Provisional Patent Application Ser. No. 60/758,172, filed Jan. 11, 2006, the disclosure of which is incorporated by reference herein in its entirety.

### BACKGROUND OF THE INVENTION

1. Field of the Invention

The present invention relates to a system and method for storing and converting energy. Particularly, the present invention is directed to a fuel cell system.

2. Description of Related Art

Fuel cell systems used in vehicular applications require a means of supplying both fuel and oxidant. The fuel for proton exchange membrane (“PEM”) fuel cells usually is pure hydrogen, or gas streams containing appreciable quantities of hydrogen. While most PEM fuel cells derive oxygen from air for use as an oxidant, those that are designed for peak efficiency typically use pure oxygen. This has been the case in most space and naval applications that demand high efficiency for systems that operate in a closed environment. In many applications, the fuel and oxidant are provided from sources external to the system—in many cases by gas tanks attached to the system. When refueling is necessary, the tanks are replaced with full ones thereby creating a series of logistics issues related to the refueling process.

The mechanism by which a PEM fuel cell generates electricity is rather simple. The balanced chemical equation is as follows:

Hydrogen Electrode: 2H₂→4H⁺+4e⁻

Oxygen Electrode: O₂+4e⁻+4H⁺→2H₂0

At the hydrogen electrode, H₂ molecules are split into H⁺ ions and electrons by the catalyst. The electrons are conducted from the hydrogen electrode to an external circuit and then to the oxygen electrode. The H⁺ ions pass through the PEM to the oxygen electrode. At the oxygen electrode, O₂ molecules are adsorbed onto the platinum catalyst. They react with the H⁺ ions, which in conjunction with electrons returned from the external circuit, join to form water (H₂0).

Regenerative fuel cells offer the benefit of being able to self-recharge through the application of an electrical power source. The regenerative fuel cell alternately operates as a fuel cell that produces power and water from hydrogen/oxygen, and as an electrolyzer that produces hydrogen/oxygen from water and electricity. In this regard, the regenerative fuel cell is a fuel cell that self-generates its own fuel.

A regenerative fuel cell requires a means for efficiently storing hydrogen and oxygen gases for critical volume/mass constrained mission scenarios that cannot exchange mass with the external environment. For many of these applications, minimization of overall system mass and volume is important in meeting critical application needs. The ability to “tradeoff” weight and volume characteristics of the system offers the system designer an additional degree of freedom in optimizing the system design since the weight and volume performance characteristics of the various reactant storage systems differ greatly from one technology to the next. For example, metal hydrides used to store hydrogen, while volume efficient, are often too heavy for an application. Storage of hydrogen in pressurized gas form can be very weight efficient, but may be too voluminous for a given application.

Additionally, unitized regenerative fuel cells often are required to operate at high pressure (3,000 psi or greater) in order to achieve compact storage of reactant gases. Because of the high pressures required of these applications, clamping forces within the cell stack become exceedingly high resulting in heavy endplates and clamping means, while sealing these fluids at high pressure requires complex manifolding thereby further adding to the overall mass of the system. Because of the high pressures involved in URFC designs, it is important to implement lightweight materials and designs in achieving low mass configurations. Conventional materials and design approaches have not met application objectives to date.

Many applications for power and energy storage require flexibility in the overall capacity for the power and energy storage components of the system in order to meet system electrical requirements. For battery systems, the power and energy storage segments are connected such that adding system capacity for power also requires that the energy storage capacity be increased. On the other hand, fuel cell systems typically are designed such that the power and energy segments are fixed for a given system. This is largely because support equipment such as pumps and blowers are sized to meet a certain capacity requirement, and cannot be easily adapted to meet changing service requirements.

What is needed is a system that is modular in nature that easily permits the addition or subtraction of incremental power and energy segments. The present invention provides a solution for these problems.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied herein and broadly described, the invention includes a fuel cell system. In accordance with one aspect, a compact unitized regenerative fuel cell system that can be easily reconfigured with changing power or energy storage requirements may be provided. Specific advances incorporated in this aspect can include a compact, integrated reactant storage system, a lightweight, low-mass and low volume modular cell architecture, and a modular system design that can be easily reconfigured for missions having differing capacity requirements. In accordance with this aspect of the invention, this configuration can be used in applications requiring a lightweight, compact, high efficiency power and energy storage system such as submersible vehicles or automobiles. Specifically, this system can be modular, self-fueling, mission reconfigurable, have no moving parts, no emissions, and can be provided with high energy and power density.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic view of a fuel cell system made in accordance with the invention.

FIG. 2(a) is a schematic view of a portion of the system depicted in FIG. 1.

FIG. 2(b) is a schematic view of process steps of a method in accordance with the invention.

FIG. 3 is a schematic illustrating a portion of a device made in accordance with the invention.

FIG. 4 is a schematic representation of a portion of a device made in accordance with the invention.

FIG. 4 is a schematic representation of another portion of a device made in accordance with the invention.

### DETAILED DESCRIPTION OF THE PREFERRED EMBODIMENT

Reference will now be made in detail to the present preferred embodiments of the invention, an example of which is illustrated in the accompanying drawings. The method and corresponding steps of the invention will be described in conjunction with the detailed description of the system.

The devices and methods presented herein may be used for storing and releasing energy. The present invention is particularly suited for fuel cell applications where a closed regenerative system is desired, such as in submarine and automotive applications.

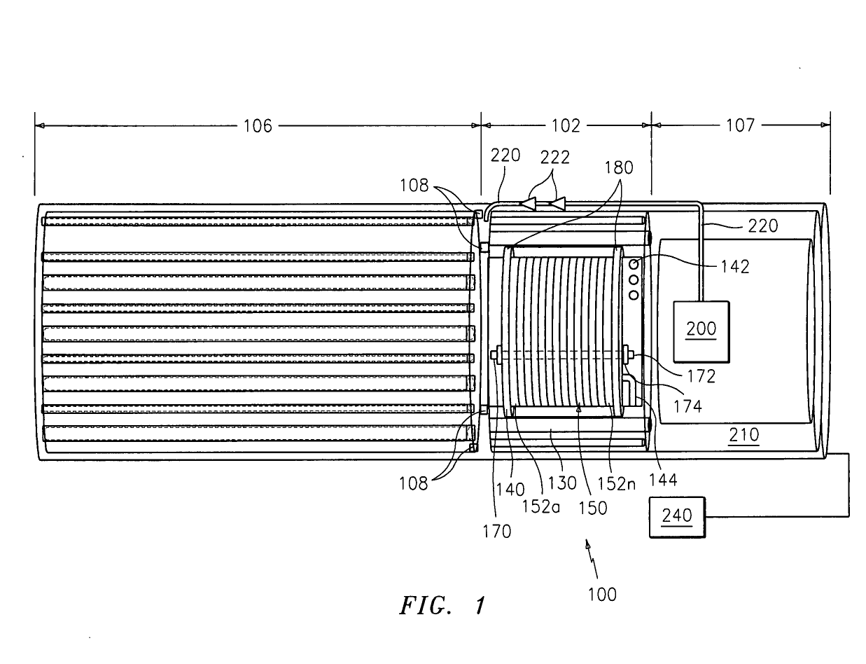

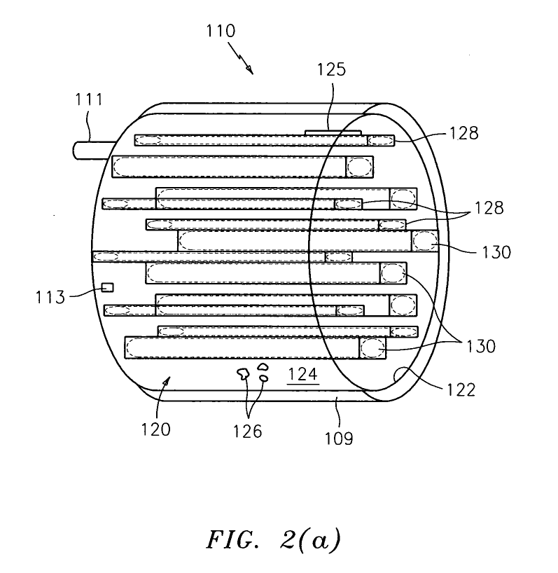

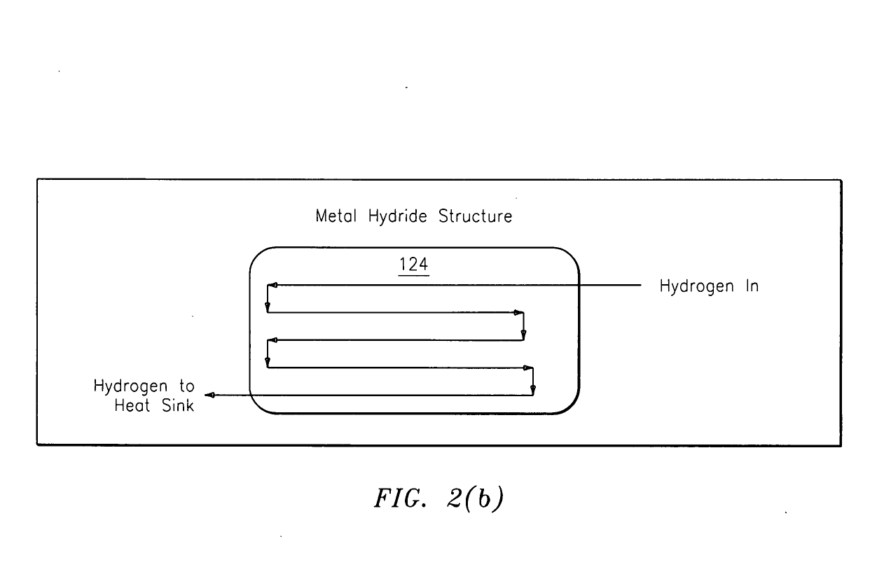

For purpose of explanation and illustration, and not limitation, a schematic view of an exemplary embodiment of a fuel cell system made in accordance with the invention is shown in FIG. 1 and is designated generally by reference character 100. Other embodiments of a fuel cell system made in accordance with the invention, or aspects thereof, are provided in FIGS. 2-5, as will be described. In order to address the deficiencies of prior art devices, the exemplary systems disclosed herein can be configured to provide compact, integrated reactant storage, a lightweight, low-mass and low-volume modular cell architecture and a modular system design that can be easily reconfigured for missions having differing capacity requirements.

For purposes of illustration, a schematic of a fuel cell system 100 made in accordance with the teachings of the present invention is depicted in FIG. 1. As embodied herein, system 100 can be provided in the form of a unitized regenerative fuel cell system 100 having a power section 102, a energy storage section 106 and a regeneration portion 107. Power section 102 and energy storage section 106 are each connected to the architecture of the overall fuel cell system 100 by means of electrical and fluids quick disconnects 108.

For purposes of illustration and not limitation, as embodied herein and as depicted in FIG. 1, energy storage section 106 of fuel cell system 100 can be modular in nature. Accordingly, energy storage section 106 includes one or more reactant storage modules 110. As depicted in FIG. 2(a), reactant storage module 110 includes a lightweight composite structure 120 having a metallized bladder 122 for containment of the reactant gases at elevated pressures, such as pressures in excess of 3000 psi.

Within this composite structure 120 is a metal hydride material 124 that stores atomic hydrogen within interstitial spaces in the lattice of material 124. The metal hydride material 124 is arranged such that larger void spaces 126 are present to allow for the storage of gaseous hydrogen. The ratio of metal hydride storage capacity to gaseous storage capacity can be modified depending on application needs and weight and volume constraints for the system. The void spaces 126 may either be single volumes, or multiple volumes having a variety of shapes, depending on the overall requirements for this system. The hydrogen gas in this system communicates directly with both the metal hydride material 124 and the void spaces 126 thereby eliminating the need for a separator or other barrier to be placed between the metal hydride 124 and the gas voids 126. Furthermore, hydrogen flow passageways 128 can also be established within the hydride material 124 to facilitate heat transfer when the metal hydride is charged and discharged with hydrogen atoms.

As illustrated in FIG. 2(b), when the metal hydride material 124 is charged, appreciable quantities of heat are released from material 124. This released heat can be effectively managed to increase the overall efficiency of the system. For example, during a charging cycle, heat released from material 124 can be used to preheat an onboard electrolyzer, raising overall system efficiency, as discussed in detail below. Moreover, when the metal hydride material 124 is discharged, heat from the fuel cell can be utilized by moving hydrogen through these same passageways to provide the necessary heat for desorption of the hydrogen. If desired, supplemental heaters 125 (e.g., resistance heaters) can also be supplied to facilitate desorption of hydrogen from material 124.

A variety of compositions of matter can be used for metal hydride material 124, as are known in the art. Any suitable metal hydride material can be used, as long as the material is reversible. That is to say, the material should be amenable to being charged and discharged repeatedly.

Thus, reactant storage module 110 can be designed to optimize the system relative to weight and volume characteristics of the reactant storage media. In module 10, hydrogen gas is stored in two separate forms—in the solid form in the interstices of metal hydride material 124 and as a pressurized gas within void spaces 126. Since metal hydrides offer a highly efficient means of hydrogen storage, and since gaseous storage at elevated pressure (>3,000 psi) offers a mass-efficient means for hydrogen storage, these two variables can be balanced to achieve specific system mass/volume constraints.

In accordance with one aspect, a fuel cell system 100 can be optimized for use in a submarine. In this setting, the weight and volume characteristics of the fuel cell system can be designed to achieve neutral buoyancy. This can be beneficial, as it can reduce the design complexities involved in integrating system 100 into a submarine.

In further accordance with the embodiment of FIGS. 1 and 2(a), oxygen gas in storage module 10 is stored as a pressurized gas within one or more thin, lightweight bladders 130 located in the pressurized hydrogen atmosphere. In this arrangement the structural containment of the pressurized oxygen gas is achieved by maintaining a pressure balance of the oxygen gas with the supporting hydrogen gas. Advantageously, consumption and generation of the hydrogen gas and oxygen gas within the fuel cell system 100 always occurs in a molar ratio of 2:1. This makes the design of the bladder 130 that maintains this pressure balance relatively straightforward.

As depicted in FIG. 2(a), the oxygen can be stored in either single or multiple bladders 130 having a variety of geometric shapes, depending on the requirements of the particular system. As can be seen, the design of energy storage section 106 can be modular by connecting multiple reactant storage modules together in order to achieve the proper energy storage capacity for the fuel cell system 100. Module 110 can be designed to accommodate pressure levels greater than or equal to 10,000 psi—a level currently being contemplated for reactant storage in many vehicular applications.

Design optimization assures that there is no overage of hydrogen or oxygen thereby wasting valuable storage media. It is also possible to provide a nested structure whereby hydrogen is contained within a metal hydride matrix that is in turn contained within a composite shroud 109 as depicted in FIG. 2(a). The metal hydride material 124 can be configured such that there exists substantial void volume within this structure for the containment of hydrogen in the gaseous form. This structure also contains volume for stored oxygen gas. The reactant storage modules 110 can also be connected with fluids disconnects 111 and assembled with pressure sensors 113 to permit monitoring of state of charge for the system, as depicted in FIG. 2(a).

In further accordance with one aspect of the invention, a power module is provided. The power module can include a fuel cell stack that is configured to be both lightweight, and regenerative.

For purposes of illustration and not limitation, as embodied herein and as depicted in FIG. 1, power section 102 can include one or more power modules 140. As depicted, power module 140 includes an electrochemical fuel cell stack 150, and supporting valving 142 and manifolding 144 that supports the electrochemical operation of the system design. Fuel cell stack 150 includes a plurality of fuel cells 152a-152n that are adapted and configured for generation of hydrogen and oxygen.

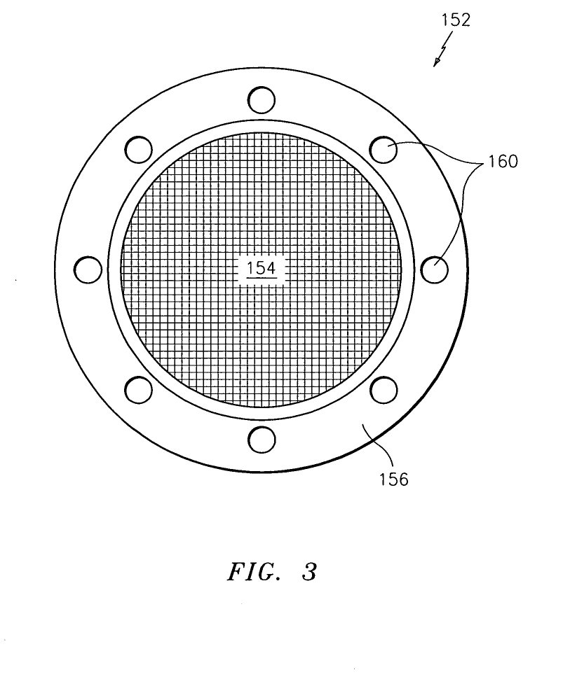

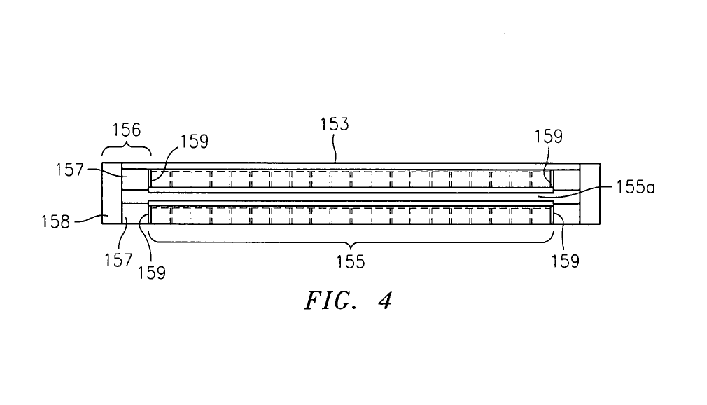

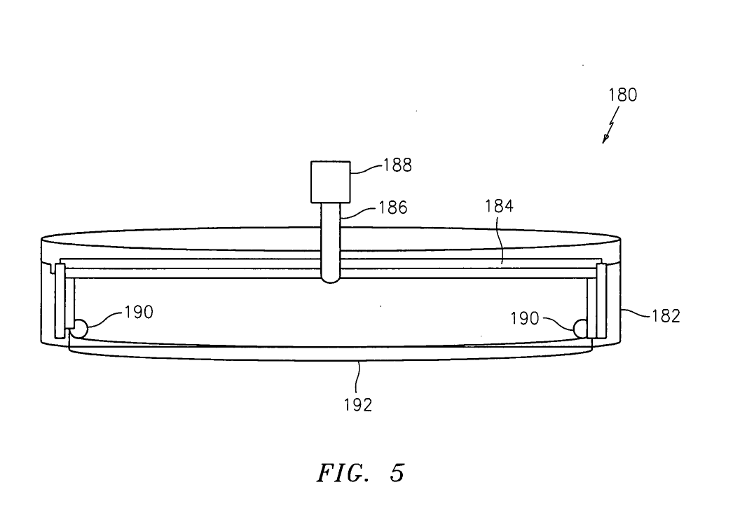

FIGS. 3 and 4 depict planar and cross sectional views of an exemplary fuel cell 152 utilizing a frame and screen architecture. As depicted in FIG. 3 cells 152 are preferably circular in shape to resist internal pressures of system 100, but other shapes (e.g., rectangular, hexagonal, oval and the like) are possible and within the scope of the invention. As further depicted in FIGS. 3 and 4, each cell 152 includes a frame 156 surrounding a flow field 154. Adjacent cells are separated by a separator layer or plate 153. Separator plate 153 can include, for example, a layer of metallic foil on the order of 5-10 thousandths of an inch thick to separate the hydrogen chambers from the oxygen chambers in fuel cell 152. Separator plate 153 can be made from various materials depending on the particular design of system 100, including, for example, carbon, titanium, niobium, zirconium, various stainless steels, nickel-based superalloys and cobalt-based superalloys, among others. Flow field 154 is coextensive with a membrane electrode assembly 155, as depicted in FIG. 4. While fuel cell 152 utilizes a frame and screen architecture, other types of architecture can be used. For example, it is possible to use a fuel cell architecture utilizing bipolar end plates, as are known in the art.

Membrane electrode assembly 155 preferably includes a Proton Exchange Membrane (“PEM”) 155a as is known in the art. The PEM utilizes an electrochemical reaction between diatomic hydrogen (H₂) and oxygen (0₂) to generate electricity, with only water and heat as byproducts. In operation, assembly 155 can be considered to include an electrolyte (i.e., the PEM), a hydrogen electrode and an oxygen electrode, a catalyst, and typically bipolar end plates. The PEM is an ion-conducting polymer, meaning that it will conduct ions while blocking the flow of electrons. This is a very important task, because it forces electrons to pass through an external circuit rather than through the membrane. The molecular structure of the polymer is an analog of Polytetrafluoroethylene (PTFE), commonly known as TEFLON, a hydrophobic polymer. PTFE is also durable and resistant to chemical attack. In order for the modified polymer to achieve its intended purpose of ion conduction, an additional process is needed. A weak sulfonic acid is ionically bonded creating strongly hydrophilic side chains. These hydrophilic sulphonate side chains attract large quantities of water, increasing the dry weight of the membrane by up to 50 percent. The end result is a material with pockets of water that allow for the conduction of protons through the membrane.

The electrodes (not shown) consist of a catalyst and a means of conducting electrons from the hydrogen electrode to the oxygen electrode. They can be constructed using either of two different methods, by way of example. The first involves applying a catalyst to a porous conductive material, such as carbon paper, that abuts the PEM. For the second method, the electrodes are built directly onto the surface of the PEM. The most effective catalyst is platinum, which is responsible for splitting the H2 molecule into positively charged hydrogen ions and electrons. Platinum particles are supported on larger carbon particles that are then imprinted directly onto the surface of the PEM. PTFE is often added with the catalyst to expel product water and help prevent the electrode from “flooding.” Next a gas diffusion layer must be applied to protect and aid in distributing the reactant gases over the catalyst. The gas diffusion layer also acts as an electrically conductive medium between the electrode and the bipolar plates. The material typically used is a porous carbon paper. However, if a unitized fuel cell system is desired, wherein the fuel cell stack is run in reverse to cause electrolysis of water, it is not desirable to use carbon. When using a fuel cell to electrolyze water, it is generally necessary to run the system at a potential of 1.5 Volts or greater, which can exacerbate corrosion of carbon materials. If a unitized system is desired, other porous conductive materials can be used in place of carbon, as discussed in detail below.

As depicted herein, the end plates 153 serve three important roles. The first is to conduct electrons to and from the external circuit. The second is to uniformly distribute the reactant gas over the electrodes to ensure the reaction will occur over as much surface area as possible. This can be achieved, for example, by passing the reactant gas through grooves in the surface of the plates. The final task is to tightly seat the fuel cell assembly so that gases cannot leak out.

As further depicted in FIG. 4, frame 156 includes pressure retention rings 157. Pressure retention rings 157 can be made from a high strength material such as plastics, including polysulfone or polyetherimid. Frame 156 also can include a composite strengthening member 158 provided to enhance the ability of each cell 152 to resist internal hoop stresses, as well as to provide column strength for stack 150. Preferably, composite strengthening member 158 is provided in the form of a composite shell that is formed external to pressure retention rings 157. Composite strengthening member 158 thus takes up the tensile stresses applied axially to the cell stack assembly to maintain sealing for the cells, as depicted in FIG. 4. The increase in strength provided to cell 152 by strengthening member 158 thus facilitates high pressure operation of system 100. Frame 156 can be further provided with an internal metallized sealing bladder film layer applied to the fluids side of the frame 156. In addition, an annularly-shaped sealing member 159 (e.g., an elastomeric o-ring of various cross sections) can be provided to help establish and maintain sealing in stack 150.

Frame 156 also defines a plurality of apertures 160. Apertures 160 in successive cells 152a-152n in a stack of n cells 152 can be aligned to permit the manifolding of fluids and passage of tie rods 170, discussed in detail below. This permits utilization of fluids manifolds located internal to the active area of the cell 152, which can save space and increase efficiency, among other advantages, including minimizing weight and endplate loading, among others. Specifically, by reducing the footprint of stack 150, the amount of force exerted on the end plates 180 is reduced for a given pressure. This permits stack 150 to be lighter, as less material can be used in the construction thereof.

As depicted in FIG. 1, tie rods 170 are provided to hold fuel cell stack 150 together. Tie rods 170 can be made of metal, and/or other materials including composite materials such as carbon fiber reinforced resin materials, precipitation hardened stainless steels, cobalt-based superalloys, and the like. Tie rods 170 hold the stack 150 together by compressing the stack components (e.g., cells 152) between two metal endplates 180. Tie rods 170 can be configured to compress stack 150 by providing tie rods 170 with threaded portions 172 that are configured to receive nuts 174.

End plates 180 are also provided to compress stack 150 via tie rods 170. In accordance with one embodiment, a composite domed endplate 180 is depicted in FIG. 5. End plate 180 utilizes process gas to help achieve compression of stack 150. This is accomplished by utilizing a lightweight composite shell 182 having a thin bladder 184 to prevent leakage of the pressurizing gas introduced through line 186 via compressor 188, or other suitable pressure inducing means, such as using the gas pressure of stack 150. As bladder 184 is pressurized it urges against fuel cell stack 150, causing the stack to pressurize. One or more sealing members 190 (such as o-rings) can also be provided to maintain the pressure in stack 150. Piston plate 192 is also provided and disposed between cells 152 and bladder 184 to exert pressure on cells 152 when bladder 184 is inflated. Plate 192 can be made of various suitable materials, including stainless steel, aluminum, copper and the like. The gas utilized in this process can be the hydrogen or oxygen process gas generated as part of the electrolysis process generated by electrolyzer 200, discussed in detail below. In this manner, no foreign gas need be introduced into the system and the weight of the package is minimized because of the composite containment for this gas.

As further shown in FIG. 1, fuel cell system also includes a regeneration portion 107. Regeneration portion includes a storage medium 210 for containing water produced by combining hydrogen and oxygen in stack 150. As embodied in FIG. 1, medium 210 is provided in the form of an annular water tank. If a discrete regenerative fuel cell system is desired, regeneration portion 107 can include an electrolyzer 200 for splitting hydrogen from oxygen to create new fuel. Electrolyzer can be brought up to operating temperature, at least in part, by directing heat released by material 124 to electrolyzer 200. This can raise the overall efficiency of system 100. Fluids manifold 220 is provided for transporting the oxygen and hydrogen generated to reactant storage module 110 to be used to generate electricity at a later time. Fluids manifold 220 also facilitates transport of water produced by cell stack 150 to storage medium 210.

Alternatively, electrolysis can simply be achieved by running fuel cell stack 150 in reverse, thus providing a unitized regenerative fuel cell system. For example, an effective way of performing electrolysis is through the use of a PEM electrolyzer, which operates basically the same way as a PEM fuel cell, but in reverse. In charge mode the balanced chemical equation is as follows:

Hydrogen Electrode: 4H⁺+4e⁻→2H₂

Oxygen Electrode: 2H₂0→0₂+4H⁺+4e⁻

The external circuit applies a voltage, and thus a current, across the electrodes. This must come from an outside source, such as supplemental power source 240, which is described in detail below. The voltage to drive the electrolysis reaction must be greater then about 1.5 volts, but no more than about 3 volts to avoid drying out the membrane. The result is that the product water from the fuel cell process that was created on the oxygen side is split into O₂ gas and H⁺ ions. The H⁺ ions pass through the PEM to the hydrogen electrode where they join with electrons provided from the external circuit to form H₂ gas.

One of the more interesting aspects of the exemplary regenerative fuel cell system embodied herein is the manner in which the product water diffuses through the membrane. The product water creation and electrolysis processes occur on the oxygen side of the membrane. Theoretically, one would assume that because of this the majority of the water should be on the oxygen side of membrane electrode assembly 155. In practice though, the opposite is true. Specifically, the major driving force behind this water diffusion is electro-osmotic drag. As hydrogen ions pass through the PEM they pull water molecules with them. In discharge mode, water will be pulled to the oxygen side. In charge mode the opposite is true. The amount of water dragged is directly proportional to the electric current. Thus, a larger current is applied in charge mode than is created in discharge mode, meaning that there will be a net gain of water molecules on the hydrogen side of the cell over time. Additional migration of water across the membrane is as result of hydraulic forces caused by pressure changes. Although only a small amount of water is present on the oxygen side of the cell, the electrolysis process still performs as outlined above. The porous nature of the PEM causes it to act as a sponge. Water is extracted from the PEM as needed by the oxygen electrode for electrolysis. In turn, the PEM will absorb some of the water present on the hydrogen side to replace what was lost to the oxygen electrode.

If stack 150 is also used to perform electrolysis in place of a separate electrolyzer 200, the gas diffusion layer should no longer be carbon paper, due to the fact that, among other things, the wastewater is stored in the cell, and operating a fuel cell in reverse at voltages in excess of 1.5 V can exacerbate damage to the carbon. Different gas diffusion layer replacement options can be used instead, including, most preferably, titanium. However, other materials, such as zirconium, tantalum, gold and niobium can also be used among others.

It is necessary to prevent water molecules from contacting metal hydride material 124, otherwise material 124 will be ineffective to store hydrogen. To achieve this, fluids manifold 220 includes a plurality of traps 222 to isolate water from material 124. A layer of porous material, such as a metal screen or other layer of porous material, such as PTFE in various commercial embodiments such as GORE-TEX® or materials such as ZITEX® from Chemplast, Inc. can also be used. Optionally silica gel or other dessicant material can also be used to help achieve this result.

In further accordance with the invention and as depicted in FIG. 1, a supplemental power source 240 can also be provided to facilitate the electrolysis of water to provide additional fuel for fuel cell system 100. By way of example, in certain applications it is foreseeable that electricity will be produced by fuel cell stack 150 periodically during periods of peak demand, significantly reducing and/or exhausting the supply of reactants in energy storage section 106. During non-peak times, a supplemental power source 240 can provide electricity to dissociate hydrogen from oxygen, facilitating recharging of reactant storage modules 110.

Supplemental power source 240 can take on a number of forms, including photoelectric panels to generate electricity of sunlight (particularly in the case of satellites), or other sources of power such as batteries, wind power, or the electric grid. Similarly, if fuel cell system 100 is incorporated into a vehicle with a conventional internal combustion engine, supplemental power source could take the form of a generator operably coupled to the internal combustion engine. Other supplemental power sources 240 are possible, including a nuclear reactor, engines operating on Stirling, Brayton or Rankine cycles, for example. The fuel cell system can be incorporated into a variety of systems and applications, including automobiles, local stationary power generation, aerospace applications including airplanes and spacecraft, naval applications such as submarines and surface vessels, and commercial applications such as energy storage for use in load leveling and peak sharing applications in electric power distribution systems.

Supplemental power source 240 can be coupled to other components of system 100 in a variety of ways. For example, if supplemental power source is relatively compact (e.g., a nuclear battery), it can be directly connected to, and integrated with the rest of the system. However, in certain applications direct connection and/or integration may not be desirable. In such circumstances, it may be desirable to provide a non-invasive coupling between supplemental power source 240 and other components of system 100 as depicted in FIG. 1.

In accordance with the teachings herein, for a given application, it is possible to provide several reactant storage modules 110 to increase the duration of which power may be generated. Additionally, multiple power modules 140 can be used if the power requirements for a new mission scenario are different than those of the prior mission. This provides the end-user an important level of reconfigurability based on specific anticipated mission or application requirements. That capability cannot be achieved with other system approaches. Moreover, as shown in FIG. 1, it is also possible to provide power section 102 with additional reactant storage, such as bladders 130 for storing oxygen alone, or surrounded by a composite metal hydride matrix as with energy storage section 106.

The methods and systems of the present invention, as described above and shown in the drawings, provide for a fuel cell system with superior properties including reduced size, simpler design and increased utility. It will be apparent to those skilled in the art that various modifications and variations can be made in the device and method of the present invention without departing from the spirit or scope of the invention. Thus, it is intended that the present invention include modifications and variations that are within the scope of the appended claims and their equivalents.

What is claimed is:

1. A fuel cell system, comprising:
a) a modular power section, the power section including at least one power module; and
b) a modular energy storage section, the energy storage section including at least one reactant storage module.

2. The fuel cell system of claim 1, wherein the power section includes a plurality of power modules.

3. The fuel cell system of claim 1, wherein the energy storage section includes a plurality of reactant storage modules.

4. The fuel cell system of claim 1, wherein at least one of the power module and reactant storage module include quick disconnect fluids fittings to operably couple the module to the fuel cell system.

5. The system of claim 1, further including a regeneration section, the regeneration section including an electrolyzer configured and adapted to dissociate water into hydrogen and oxygen received from the power module via a fluids manifold.

6. The fuel cell system of claim 5, wherein the regeneration section is in operable communication with the energy storage section, the regeneration section being configured to direct hydrogen and oxygen from the electrolyzer to the energy storage section.

7. The fuel cell system of claim 5, wherein a fuel cell stack produces electricity in a first operative mode, and performs electrolysis in a second operative mode.

8. The fuel cell system of claim 5, further including a supplemental power source, the supplemental power source being operably coupled to the electrolyzer.

9. A fuel cell system, comprising:
a) a modular power section, the power section including at least one power module; and
b) a modular energy storage section, the energy storage section including at least one reactant storage module, wherein the weight and volume characteristics of the fuel cell system are designed to achieve neutral buoyancy.

10. The fuel cell system of claim 9, wherein the fuel cell system is configured and adapted for use in an underwater vehicle.

11. The fuel cell system of claim 10, wherein the fuel cell system is configured and adapted for use in a submarine.

12. A power system, comprising:
a) a regenerative fuel cell system including:
i) a modular power section, the power section including at least one power module; and
ii) a modular energy storage section, the energy storage section including at least one reactant storage module; and
b) an external power source operably coupled to the fuel cell system and a power distribution network.

13. The system of claim 12, wherein the system is adapted and configured to direct electrical power from the external power source to the fuel cell system during off peak periods.

14. The system of claim 13 wherein the system is further adapted and configured to draw electrical power from the fuel cell system during peak usage periods and deliver the power through the power distribution network.

15. The system of claim 12, wherein the fuel cell system further includes a regeneration section having an electrolyzer, the electrolyzer adapted and configured to electrolyze water.

16. The system of claim 12, wherein the fuel cell system includes a fuel cell stack, the stack being adapted and configured to operate in an electrolysis mode to electrolyze water.

17. The system of claim 12, wherein the power distribution system is operably coupled to a stationary electrical grid.

18. The system of claim 12, wherein the power distribution system is operably coupled to a vehicle.

19. The system of claim 18, wherein the vehicle is an automobile.

20. The system of claim 18, wherein the vehicle is an aircraft.
